(19) United States
(12) Patent Application Publication
(10) Pub. No.: US 2014/0182433 A1
(43) Pub. Date: Jul. 3, 2014

(54) CUTTING DEVICE OF WEB MEMBER INCLUDING TOW

(71) Applicant: UNICHARM CORPORATION, Ehime (JP)

(72) Inventors: Kunihiko SAITO, Kanonji-shi (JP); Kazuhiko HOSHIKA, Kanonji-shi (JP)

(73) Assignee: UNICHARM CORPORATION, Ehime (JP)

(21) Appl. No.: 13/749,713

(22) Filed: Jan. 25, 2013

(30) Foreign Application Priority Data
Dec. 29, 2012 (JP) 2012-289176

(51) Int. Cl. B26D 7/18

(52) U.S. Cl. CPC B26D 7/1818; B26D 7/1863
USPC 83/81

(57) ABSTRACT

The cutting device of the present invention is provided with a movement mechanism which moves together with a rotary blade member which is immovably fastened and which guides reciprocating movement of the movement mechanism, and a bearing which is placed between the guide mechanism and the movement mechanism to enable smooth movement of the movement mechanism with respect to the guide mechanism and, furthermore, is provided with a waste removing device which is attached to the movement mechanism and which blocks entry of fiber waste which is produced when cutting the continuous web member to the inside of the bearing by removing fiber waste which has deposited on said guide mechanism from the guide mechanism.

### TECHNICAL FIELD

The present invention relates to a cutting device of a web member including a tow.

### BACKGROUND ART

As a web member which includes a tow, for example, a cleaning-use web member which is comprised of a combination of the web member and another handle member and is used for cleaning a desktop is known (see PTL 1). Such a cleaning-use web member is comprised having a substrate sheet and a plurality of fibrous members which are laid over the substrate sheet and are integrally bonded. The fibrous members are formed from tows, that is, extremely large number of filaments (long fibers) bundled together, for example, are formed from fiber bundles which include thermoplastic fibers.

Such a cleaning-use web member is formed by stacking and fastening a plurality of continuous tows on a continuous substrate sheet which advances in a machine direction of a production line whereby a continuous web member comprised of a substrate sheet and a plurality of tows joined together (that is, a continuous web member with no cuts) is formed, then cutting the continuous web member into a predetermined product length.

Here, as a method of cutting a continuous web member into a predetermined product length, use of a cutting device such as disclosed in PTL 2 may be considered. That is, it may be considered to run a continuous web member between a cutter roller which has a cutter blade at its outer circumference and an anvil roll which has an anvil blade which receives the cutter blade and to clamp the continuous web member between the cutter blade and anvil blade to cut it.

### CITATIONS LIST

### Patent Literature

[PTL 1] Japanese Unexamined Patent Publication No. 2005-40641 A1

[PTL 2] Japanese Unexamined Patent Publication No. 2011-62802 A1

[PTL 3] Japanese Patent Application No. 2012-115783 Specification

### SUMMARY OF INVENTION

### Technical Problem

However, the continuous web member includes a tow, so when cutting the continuous web member, due to clamping pressure between the cutter blade and anvil blade, the obstacle is liable to be caused of melt bonding or press bonding between the tows occurring at the cut part, the cut ends of the web member ending up being closed in a bag-like manner, and the function as a brush sheet (function of capturing dust at the time of cleaning) not being able to be sufficiently exhibited.

For this reason, to avoid the melt bonding or press bonding which occurs between tows at the time of cutting, a cutting device which conveys the continuous web member intermittently and, while the continuous web member has stopped being conveyed, makes a disk-shaped rotary blade member rotate about a rotation axis along the machine direction while makes it reciprocate in a perpendicularly intersecting direction which perpendicularly intersects the machine direction so as to cut the continuous web member is being developed (see PTL 3).

In this regard, in the cutting device such as disclosed in PTL 3, a drive mechanism becomes necessary for making the disk-shaped rotary blade reciprocate. Such a drive mechanism is configured having a movement mechanism which moves together with the rotary blade member and a guide mechanism such as a rail mechanism which is immovably fastened and which guides reciprocating movement of the movement mechanism. Further, to enable smooth movement of the movement mechanism with respect to the guide mechanism, a ball bearing or other such bearing is provided between the guide mechanism and the movement mechanism. Such a bearing is generally provided with a seal mechanism to avoid refuse etc. which would hinder the function entering into the bearing etc.

However, when a tow is cut, fiber waste is produced. This fiber waste is fine in size. Further, sometimes the amount is also large. If an unforeseen large amount of fine fiber waste which would exceed the sealing ability of a bearing were to be produced and deposit, the fiber waste would end up entering the inside of the bearing. This would sometimes obstruct the operation of the system.

The present invention, in view of such problems, has as its object the provision of a cutting device of a web member including a tow which conveys a continuous web member intermittently and, while the continuous web member has stopped being conveyed, makes a disk-shaped rotary blade member rotate about a rotation axis along the machine direction while makes it reciprocate in a perpendicularly intersecting direction which perpendicularly intersects the machine direction so as to cut the continuous web member into a predetermined product length, which cutting device has means able to block fiber waste which is produced at the time of cutting the continuous web member from invading the inside of a bearing which is provided so as to cause reciprocating movement of the rotary blade member.

### Solution to Problem

According to the aspect of the invention which is described in claim 1, there is provided a cutting device of a web member including a tow which conveys a continuous web member intermittently and, while the continuous web member has stopped being conveyed, makes a disk-shaped rotary blade member rotate about a rotation axis along the machine direction while makes it reciprocate in a perpendicularly intersecting direction which perpendicularly intersects the machine direction so as to cut the continuous web member into a predetermined product length, which cutting device is provided with a movement mechanism which moves together with the rotary blade member, a guide mechanism which is immovably fastened and which guides reciprocating movement of the movement mechanism, and a bearing which is placed between the guide mechanism and the movement mechanism to enable smooth movement of the movement mechanism with respect to the guide mechanism and, furthermore, is provided with a waste removing device which is attached to the movement mechanism and which blocks entry of fiber waste which is produced when cutting the continuous web member to the inside of the bearing by removing fiber waste which has deposited on the guide mechanism from the guide mechanism.

That is, in the aspect of the invention which is set forth in claim 1, a waste removing device is provided which is attached to the movement mechanism and which removes fiber waste which has deposited on the guide mechanism from the guide mechanism so as to block entry of fiber waste produced when cutting the continuous web member to the inside of the bearing, whereby even if an unforeseen large amount of fine fiber waste which would exceed the sealing ability of the bearing were to be produced and deposit, the fiber waste which deposits on the guide mechanism can be removed from the guide mechanism and fiber waste can be blocked from entering to the inside of the bearing more reliably.

According to the aspect of the invention which is set forth in claim 2, there is provided the cutting device as set forth in claim 1 wherein the guide mechanism has a rail member which has guide surfaces against which the bearing slides and wherein the waste removing device is provided with a waste removing body which is formed having waste removing surfaces which are complementary to the guide surfaces so that fiber waste which has deposited at the guide surfaces of the rail member can be removed.

According to the aspect of the invention which is set forth in claim 3, there is provided the cutting device as set forth in claim 2 wherein the waste removing body is formed by a cloth.

According to the aspect of the invention which is set forth in claim 4, there is provided the cutting device as set forth in claim 3 where the waste removing device has a suction device which is attached to the guide mechanism and which is arranged adjoining the rail member so as to be able to suck away fiber waste which has been deposited on the guide surfaces of the rail

### Advantageous Effects of Invention

According to the aspects of the invention described in the claims, the shared effects are exhibited of providing a cutting device of a web member including a tow which has a movement mechanism which moves together with a rotary blade member and a guide mechanism which is immovably fastened and which guides reciprocating movement of the movement mechanism and which is provided with a bearing between the guide mechanism and the movement mechanism, wherein it is possible to block entry of fiber waste to the inside of the bearing when the continuous web member is cut and it is possible to keep obstacles to operation such as able to be caused by the fiber waste from arising.

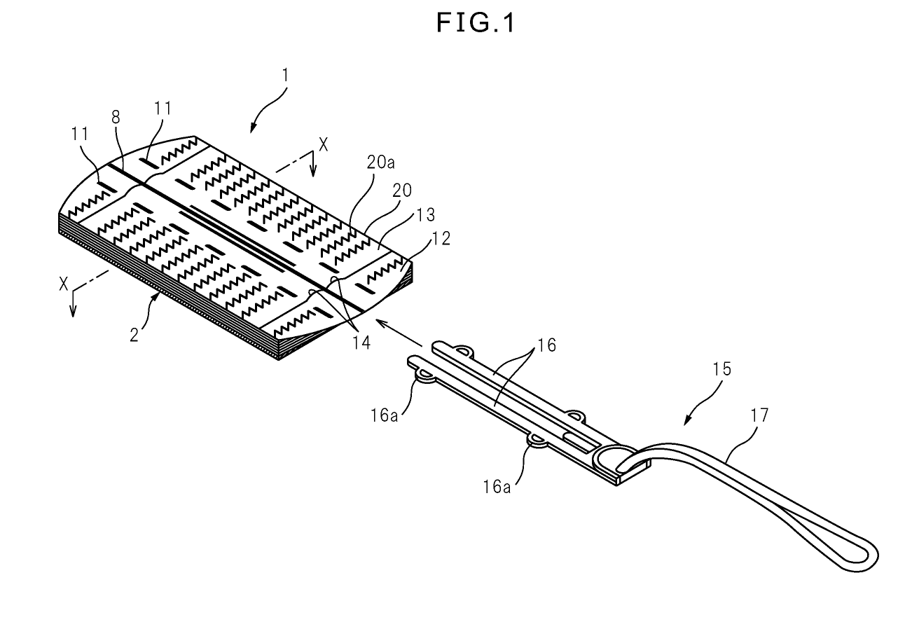

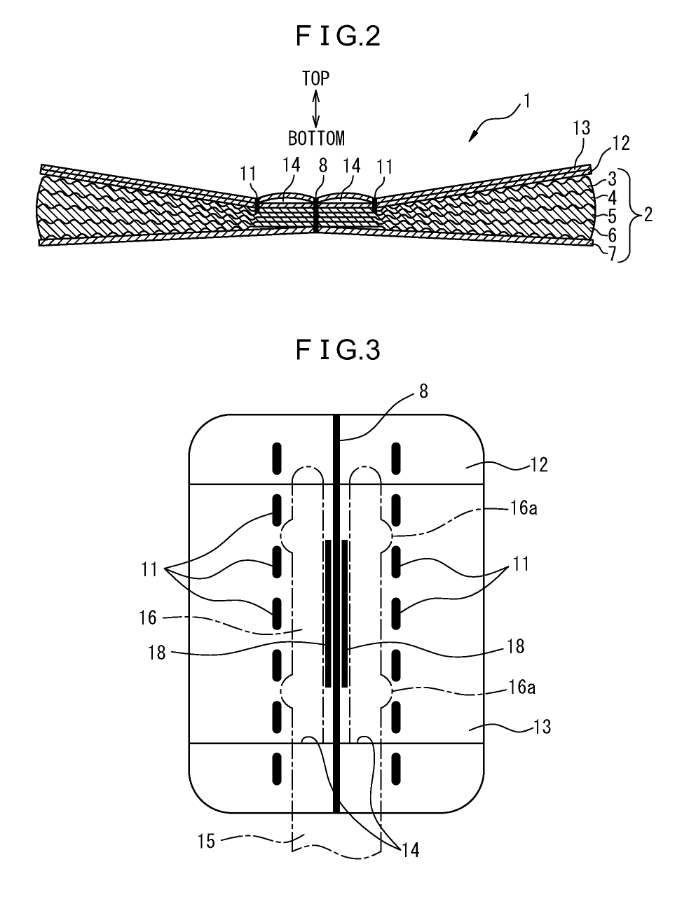

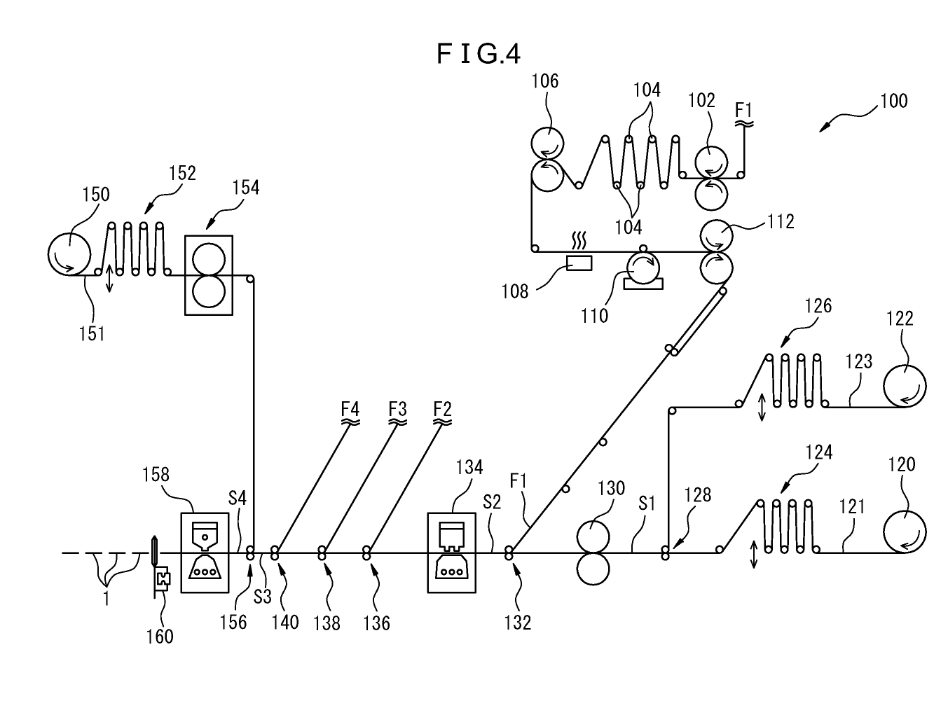

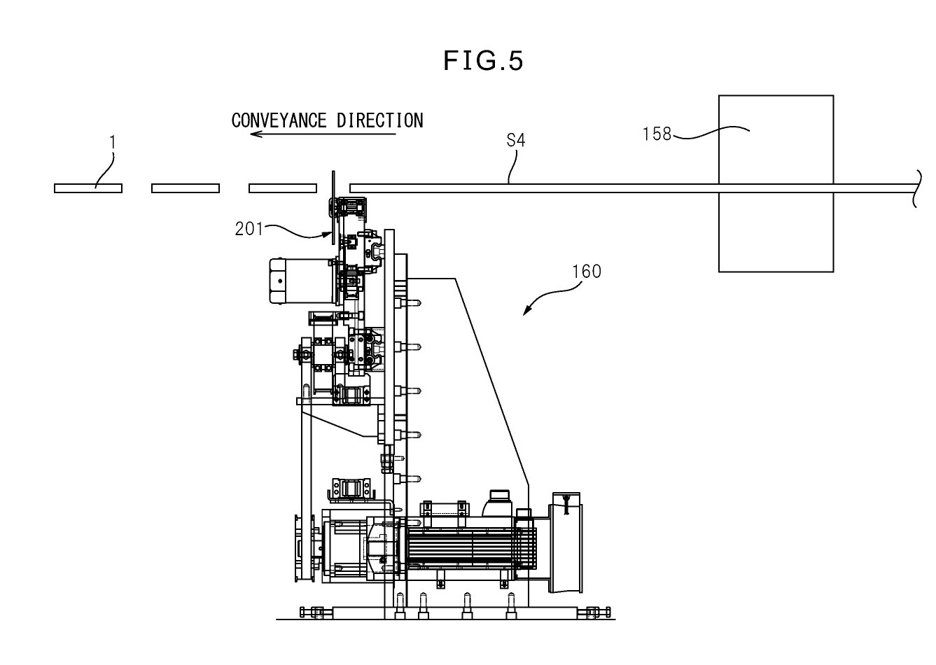

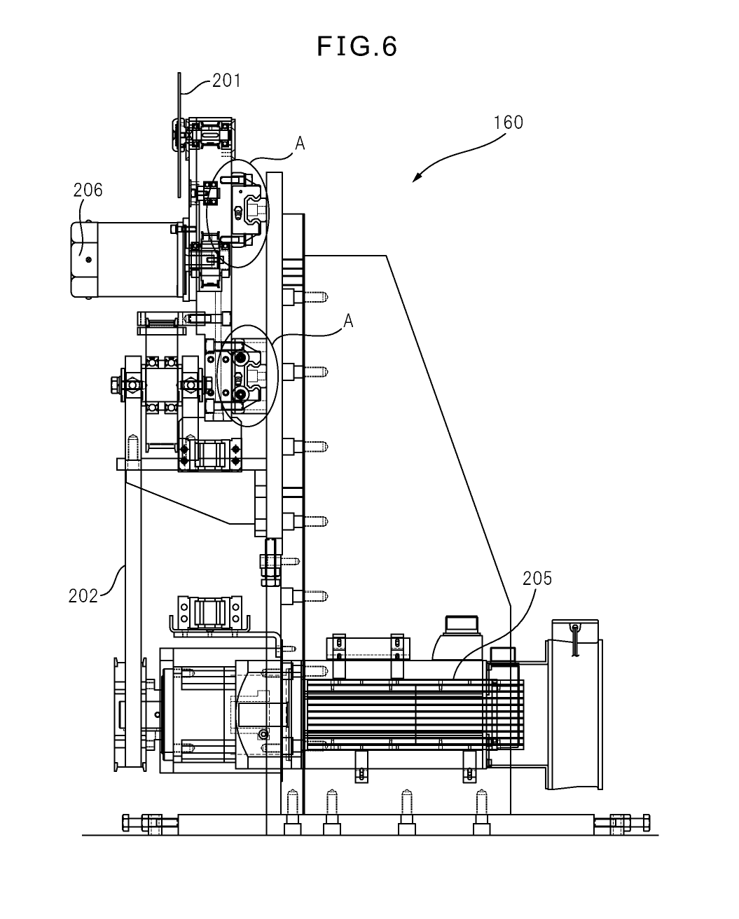

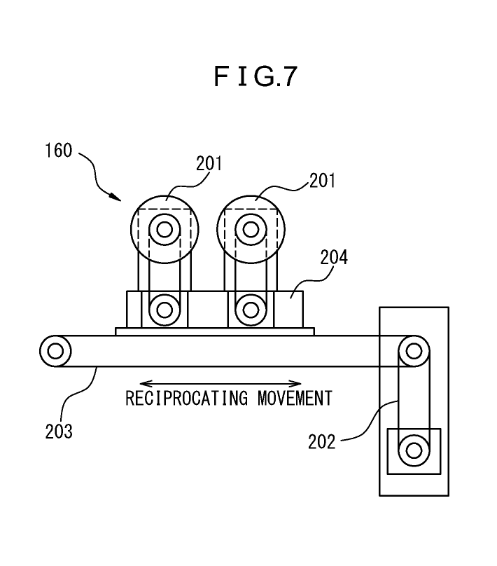

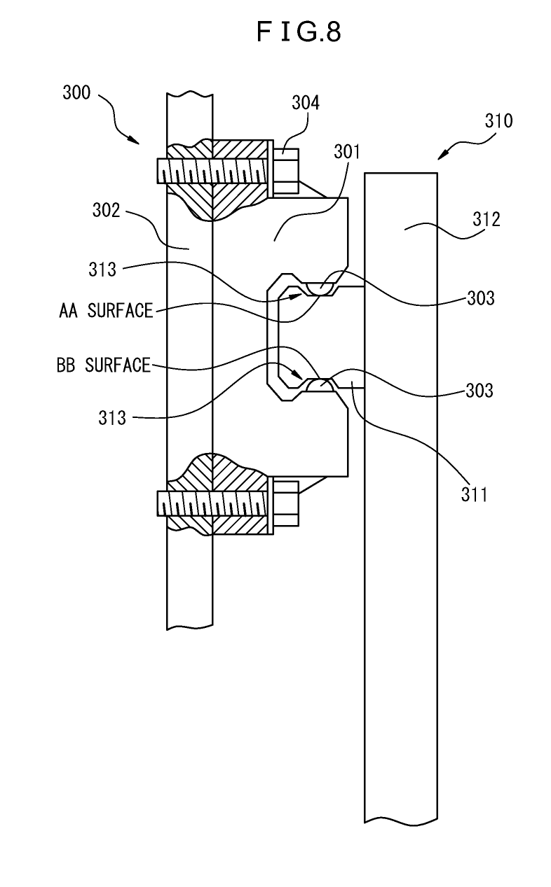

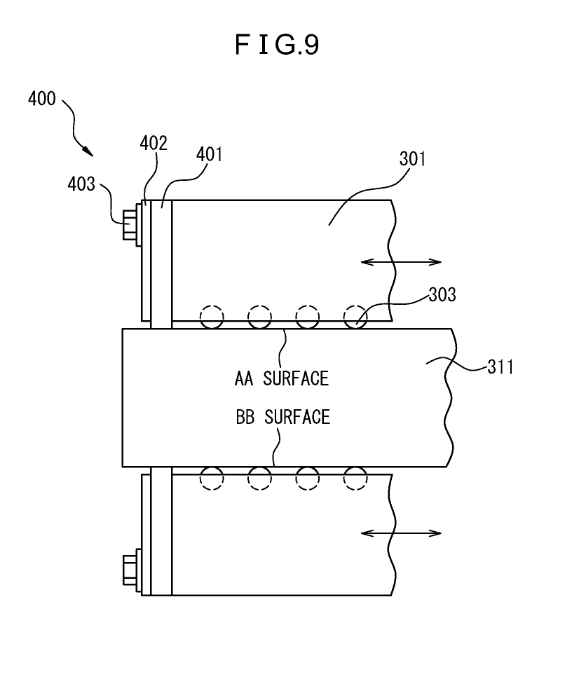

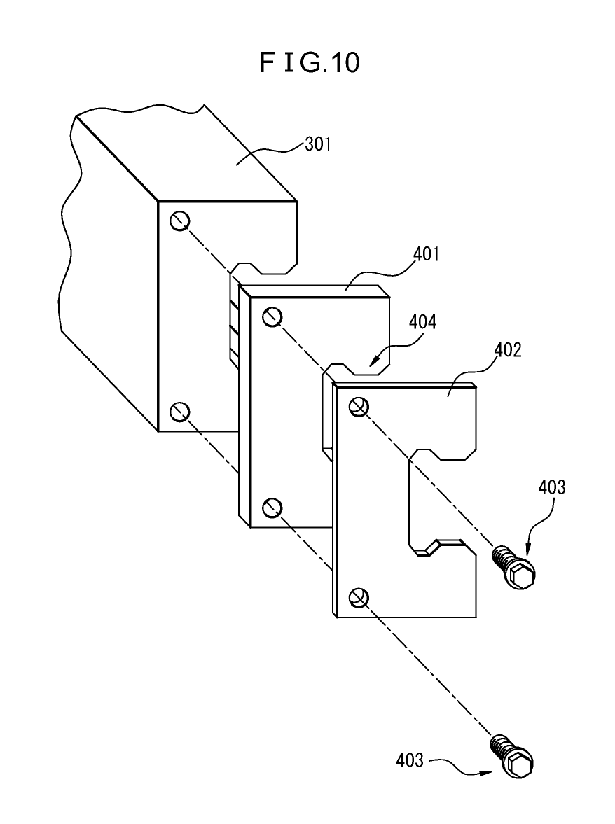

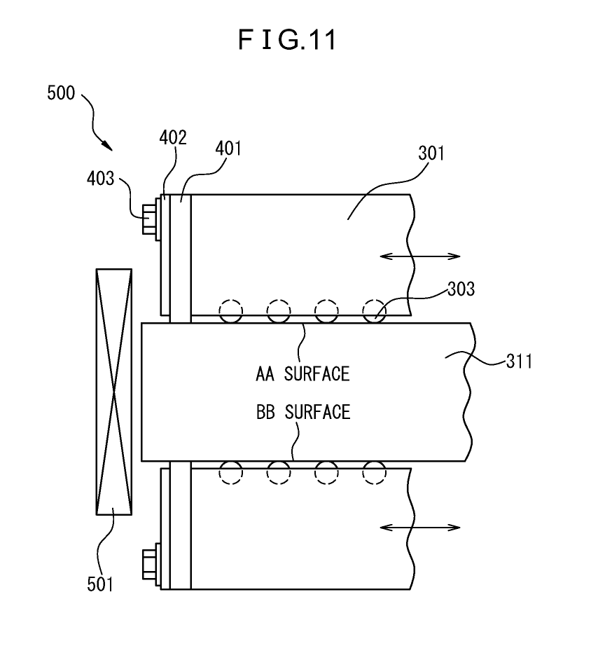

### BRIEF DESCRIPTION OF DRAWINGS

[FIG. 1] is a perspective view which shows a web and handle as a whole.

[FIG. 2] is a cross-sectional view along the line X-X of FIG. 1.

[FIG. 3] is a plan view of a web member.

[FIG. 4] is a schematic view for explaining an embodiment of a system for producing a cleaning-use web member shown in FIG. 1.

[FIG. 5] is a view which shows an outline of the layout of a cutting device.

[FIG. 6] is an overview of a cutting device.

[FIG. 7] is a view which explains the operation of a cutting device.

[FIG. 8] is a view which shows the configuration of a part A in FIG. 6.

[FIG. 9] is a view which shows an embodiment of a waste removing device of a cutting device according to the present invention.

[FIG. 10] is a perspective view which shows the configuration of the waste removing device which is shown in FIG. 9.

[FIG. 11] is a view which shows a waste removing device of another embodiment.

### DESCRIPTION OF EMBODIMENTS

First, an embodiment of the configuration of a cleaning-use web member which can be formed by using a cutting device according to the present invention and a handle which is fastened to this cleaning-use web member will be explained with reference to FIG. 1 to FIG. 3. FIG. 1 is a perspective view which shows a cleaning-use web member 1 and handle 15 as a whole, FIG. 2 is a cross-sectional view along the line X-X of FIG. 1, and FIG. 3 is a plan view of the cleaning-use web member 1 of FIG. 1.

That is, this cleaning-use web member 1 is provided with a brush sheet 2 (shaggy part) which has a plurality of fibrous members 3, 4, 5, 6 and a sheet with slits 7 which is overlaid at the bottom part of the fibrous member 6, a substrate sheet 12 which is overlaid at the top part of the brush sheet 2, and a holding sheet 13 which is overlaid at the top part of the substrate sheet 12. Between the substrate sheet 12 and the holding sheet 13, receiving parts 14 are provided for receiving the insert parts 16 of the handle 15. Note that, the top direction in FIG. 2 will be explained as “top” and the bottom direction as “bottom”.

Note that, the cleaning-use web member 1 of the present embodiment is provided with two receiving parts 14 so as to enable insertion of two branched insert parts 16. However, in other embodiments, the insert parts 16 may also be branched into three or more parts. The cleaning-use web member 1 is provided with the receiving parts 14 in accordance with the number of branches at the insert parts 16.

The brush sheet 2, in the embodiment which is shown in FIG. 2, is provided with four-layer structure fibrous members 3 to 6 comprised of a first fibrous member 3, a second fibrous member 4 which is overlaid at the bottom part of the first fibrous member 3, a third fibrous member 5 which is overlaid at the bottom part of the second fibrous member 4, and a fourth fibrous member 6 which is overlaid at the bottom part of the third fibrous member 5 and with a sheet with slits 7 which is overlaid at the bottom part of the fourth fibrous member 6 of this four-layer structure fibrous members 3 to 6. Note that, the fibrous members of the brush sheet 2 are not limited to a four-layer structure such as in the present embodiment and may also be a single layer, two-layer, three-layer, or five-layer or more structure. Further, in another embodiment, the brush sheet 2 is not provided with the sheet with slits 7.

The first fibrous member 3, second fibrous member 4, third fibrous member 5, and fourth fibrous member 6 of the brush sheet 2 are treated by dust catching oil comprised mainly of for example liquid paraffin having the action of promoting adsorption of dust, dirt, etc.

The first fibrous member 3, second fibrous member 4, third fibrous member 5, and fourth fibrous member 6 of the brush sheet 2 can be formed by opening a fiber bundle such as a tow. Note that, in the Specification, a “tow”, as described in JIS L 0204-3: 1998, section 3.1.24, means a bundle of an extremely large number of filaments aligned together.

As the fiber bundle, for example, a fiber bundle comprised of thermoplastic fibers, a fiber bundle including thermoplastic fibers, etc. may be mentioned. As the material of the fibers forming the fiber bundle, for example, polyethylene, polypropylene, polyethylene terephthalate, nylon, rayon, etc. may be mentioned. As the fibers forming the fiber bundle, for example, monofilaments and composite fibers, for example, core-sheath type composite fibers or side-by-side type composite fibers etc. may be mentioned. As the composite fibers, core-sheath type composite fibers are preferable. Furthermore, core-sheath type composite fibers with a melting point of the core higher than the melting point of the sheath are more preferable from the viewpoint of thermal bondability. As core-sheath type composite fibers, core-sheath type composite fibers with a core comprised of polypropylene or polyethylene terephthalate and a sheath comprised of polyethylene are more preferable and further core-sheath type composite fibers with a core comprised of a polyethylene terephthalate and a sheath comprised of polyethylene are still more preferable.

The denier of the fibers which forms the fiber bundle is preferably 1 to 50 dtex, more preferably 2 to 10 dtex. The fiber bundle may include a plurality of types of fibers which have the same denier or may include one or more types of fibers which have different deniers.

The fiber bundle may also be a bundle of slit fibers (fibers obtained by cutting and stretching a film in an elongated manner), split fibers (fibers obtained by dividing an elongated film into a net structure), etc.

The filaments which form the fiber bundle, that is, the long fibers, are comprised of crimped fibers. By forming the filaments by crimped fibers, it is possible to increase the bulk of the fiber bundle and possible to make the crimped parts structures which easily take in dust, dirt, etc. On the other hand, depending on the conditions of the production line etc., sometimes fibers which are not crimped are suitable for use as filaments. In such a case, the filaments are formed by fibers which are not crimped.

The sheet with slits 7, in the same way as the substrate sheet 12 and holding sheet 13, is formed from a nonwoven fabric which is comprised of thermoplastic fibers (thermal bondable fibers) or a nonwoven fabric which includes thermoplastic fibers and is formed into a rectangular shape of substantially the same width and substantially the same length as the substrate sheet 12. The sheet with slits 7 is provided with sawtooth shaped slits (not shown) at predetermined intervals across the entire sheet with slits 7. Due to the slits, across the entire length of the two edge parts in the width direction of the sheet with slits 7, the two edges are formed with sawtooth shaped reed-shaped parts (not shown).

At the top part of the first fibrous member 3 of the brush sheet 2, as shown in FIG. 1 to FIG. 3, the substrate sheet 12 and the holding sheet 13 are overlaid in that order. Between the substrate sheet 12 and the holding sheet 13, receiving parts 14 are provided for insertion of insert parts 16 of the handle 15.

The substrate sheet 12 and the holding sheet 13 have rectangular shapes. The two sheets 12 and 13, as shown in FIG. 3, are set to the same dimensions in the width direction (left-right direction of FIG. 3), while the substrate sheet 12 is set longer in dimension in the length direction (up-down direction of FIG. 3). The holding sheet 13 is overlaid on the top part of the substrate sheet 12 so that two end parts of the substrate sheet 12 in the long direction stick out outward from the two ends of the holding sheet 13 in the long direction by predetermined lengths.

The substrate sheet 12 and holding sheet 13 are formed from nonwoven fabrics which are comprised of thermoplastic fibers (thermal bondable fibers) or nonwoven fabrics which include thermoplastic fibers. As thermoplastic fibers, for example, polyethylene fibers, polypropylene fibers, polyethylene terephthalate fibers, polyethylene and polyethylene terephthalate composite fibers, polyethylene and polypropylene composite fibers, core-sheath type composite fibers comprised, for example, of a core comprised of polyethylene terephthalate and a sheath comprised of polyethylene, etc. may be mentioned. As types of nonwoven fabrics, for example, thermal bond nonwoven fabrics, spunbonded nonwoven fabrics, spunlace nonwoven fabrics, etc. may be mentioned.

As other embodiments, embodiments in which the substrate sheet and the holding sheet are formed from thermoplastic resin films, for example, polyethylene films and polypropylene films, may be mentioned, while as further embodiments, embodiments in which the substrate sheet and the holding sheet are formed from laminate sheets of nonwoven fabrics and resin films may be mentioned.

The substrate sheet 12 and the holding sheet 13 are integrally melt bonded by a later explained first melt bonded part forming device 158 together with all of the layers of the brush sheet 2 (first fibrous member 3, second fibrous member 4, third fibrous member 5, fourth fibrous member 6, and sheet with slits 7), whereby, as shown in FIG. 1 to FIG. 3, a first melt bonded part 8 extending in the long direction at the center part in the width direction is formed. Furthermore, the substrate sheet 12 and the holding sheet 13 are integrally melt bonded at the two sides of the first melt bonded part 8 (left and right in FIG. 2) by two later explained second melt bonded part forming devices 134 together with one layer of the brush sheet 2 (first fibrous member 3), whereby two second melt bonded parts 11 are formed intermittently in the length direction. By the first fibrous member 3 being melt bonded with the substrate sheet 12 and the holding sheet 13, the first fibrous member 3 tracks movement of these sheets 12 and 13, so in the state of use, the brush sheet 2 easily becomes broader and, and in turn, the cleaning efficiency is improved.

The substrate sheet 12 and the holding sheet 13 are melt bonded at the first melt bonded part 8 with all layers of the brush sheet 2 (first fibrous member 3, second fibrous member 4, third fibrous member 5, fourth fibrous member 6, and sheet with slits 7) and is melt bonded with the first fibrous member 3 of the brush sheet 2 at the two second melt bonded parts 11. Due to this, between the substrate sheet 12 and the holding sheet 13, a pair of receiving parts 14 which are comprised of bag-shaped spaces which are defined by the first melt bonded part 8 and the two second melt bonded parts 11, which extend in the long direction of the substrate sheet 12 and the holding sheet 13, and which are open at the two ends in the long directions are provided. As a result, the receiving parts 14 can receive the insert parts 16 of the handle 15.

The substrate sheet 12 and the holding sheet 13 are melt bonded by the two second melt bonded part forming devices 134 with the first fibrous member 3 of the brush sheet 2 at the center parts of these. A pair of melt bonding lines 18 are further formed at a predetermined interval in the width direction of the substrate sheet 12 and the holding sheet 13. Between the pair of melt bonding lines 18, the first melt bonded part 8 is formed. The pair of melt bonding lines 18 are marks for management of the position of the first melt bonded part 8 at the stage of production. By managing whether the first melt bonded part 8 is arranged between the marks constituted by the pair of melt bonding lines 18 by sensors etc., it is possible to separate good products and bad products.

The two second melt bonded parts 11 are provided intermittently at several locations in the long directions of the substrate sheet 12 and the holding sheet 13. By engaging the arc-shaped projections 16a of the insert parts 16 of the handle 16 between two second melt bonded parts 11 which are aligned in the length direction and adjoin each other, the insert parts 16 of the handle 15 can be prevented from being pulled out from the receiving parts 14.

The two edge parts of the substrate sheet 12 and the holding sheet 13 in the width direction (outside parts of two second melt bonded parts 11), as shown in FIG. 1, are provided with sawtooth shaped slits 20a at predetermined intervals along the long direction. Due to the slits 20a, the two edges are provided with sawtooth shaped reed-shaped parts 20. In another embodiment, the substrate sheet 12 and the holding sheet 13 are not provided with sawtooth shaped slits 20a and therefore the reed-shaped parts 20 are not provided.

Note that the handle 15 is formed from a plastic etc. As shown in FIG. 1, it has a pair of long plate-shaped insert parts 16 which are arranged in parallel to each other, a pair of arc-shaped projections 16a which stick out from the outside surfaces of the two ends parts in the long directions of the insert parts 16, and a holder 17 which is provided integrally with one of the end parts of the insert parts 16.

By inserting the two insert parts 16 of the handle 15 inside the two receiving parts 14 of the cleaning-use web member 1 configured in this way and engaging the projections 16a between two second melt bonded parts 11 which are aligned in the length direction and adjoin each other, the cleaning-use web member 1 is attached to the handle 15.

Further, by holding the holder 17 of the handle 15, bringing the brush sheet 2 into contact with a location being cleaned, and making it move in the desired direction, the dust, dirt, etc. of the location being cleaned is trapped by the brush sheet 2 and the location being cleaned is cleaned.

Next, the method of production of the above-mentioned cleaning-use web member 1 will be explained. FIG. 4 is a schematic view for explaining one embodiment of the production system for producing the cleaning-use web member which is shown in FIG. 1.

First, in the production system of the present embodiment, a crimped first fiber bundle F1 is taken out from a container (not shown) and is fed to first nip rolls 102. The first nip rolls 102 rotate by a certain peripheral velocity V1 whereby the first fiber bundle F1 is sent in the machine direction MD. After passing through the first nip rolls 102, the first fiber bundle F1 passes through the tension rolls 104 and reaches the second nip rolls 106.

The peripheral velocity V2 of the second nip rolls 106 becomes faster than the peripheral velocity V1 of the first nip rolls 102. Due to this, between these nip rolls 102 and 106, the first fiber bundle F1 is given tension. As a result, the first fiber bundle F1 is opened.

Here, the tension rolls 104 are made large in mass so that self rotation is not easily caused, for example, are formed from solid bars made of steel. Due to this, sudden tension will not be applied to the first fiber bundle F1 which turns the tension rolls 104 while advancing from the first nip rolls 102 toward the second nip rolls 106.

Further, the tension rolls 104 are arranged to be able to gradually open the first fiber bundle F1 by the stroke between the first nip rolls 102 and the second nip rolls 106 becoming longer.

The first fiber bundle F1 which passes through the second nip rolls 106 passes through an air feeder 108 and oil applicator 110 and reaches third nip rolls 112. The peripheral velocity V3 of the third nip rolls 112 is slower than the peripheral velocity V2 of the second nip rolls 106. Therefore, the first fiber bundle F1 which advances between the second nip rolls 106 and the third nip rolls 112 is opened and the width of the first fiber bundle F1 is expanded.

Incidentally, the oil applicator 110 which is arranged between the second nip rolls 106 and the third nip rolls 112 performs the role of applying dust collecting oil having the action of promoting adsorption of dust, dirt, etc. to the first fiber bundle. The dust collecting oil is for example an oil which is mainly comprised of liquid paraffin.

The first fiber bundle F1 which passes the third nip rolls 112 proceeds to the merging part 132.

On the other hand, the nonwoven fabric 121 which forms the substrate sheet 12 is continuously unrolled from a nonwoven fabric roll 120. The nonwoven fabric 121 passes through a first roll group 124 which includes a plurality of rolls arranged in two top/bottom stages and where the dancer rolls which are positioned at the bottom stage rock up and down whereby it is intermittently conveyed. Here, “intermittently conveyed” means the nonwoven fabric 121 is repeatedly advanced by exactly a certain distance, for example, substantially the width direction length of the cleaning-use web member 1, in the machine direction, then stopped from being conveyed for a certain time. By the nonwoven fabric being intermittently conveyed in this way, it is possible to secure the time for melt bonding the component elements of the later explained multilayer web.

Similarly, the nonwoven fabric 123 which forms the holding sheet 13 is continuously unrolled from a nonwoven fabric roll 122. The nonwoven fabric 123 is passed through a second roll group 126 which includes a plurality of rolls arranged in two top/bottom stages and where the dancer rolls which are positioned at the bottom stage rock up and down whereby it is intermittently conveyed.

The nonwoven fabric 121 and the nonwoven fabric 123 merge at the merging part 128 to form a multilayer web S1. The multilayer web S1 passes the gather cutters 130 which have sawtooth shaped blades (not shown) intermittently formed at their surfaces in the peripheral direction. Due to this, the slits 20a which are shown in FIG. 1 are formed at the substrate sheet 12 and the holding sheet 13.

Next, at the merging part 132, the multilayer web S1 and the fiber bundle F1 merge whereby the multilayer web S2 is formed. Incidentally, the fiber bundle F1 is conveyed with a certain degree of slack between the third nip rolls 112 and merging part 132 so the fiber bundle F1 can move suitably tracking the intermittent movement of the multilayer web S1.

In the present embodiment, the two second melt bonded part forming devices 134 are used to melt bond the substrate sheet 12, holding sheet 13, and first fiber bundle F1 included in the multilayer web S2 whereby two second melt bonded parts 11 (FIG. 3) are formed. Due to this, the multilayer web S2 is melt bonded across its thickness direction. The two second melt bonded part forming devices 134, for example, are heat seal devices, ultrasonic wave sealing devices, etc. As another embodiment, ultrasonic wave sealing devices are used.

After this, at the multilayer web S2, a second fiber bundle F2 to fourth fiber bundle F4 which are opened by the same method as the first fiber bundle F1 are successively overlaid whereby a multilayer web S3 is formed.

On the other hand, the nonwoven fabric 151 is continuously unrolled from a nonwoven fabric roll 150. The nonwoven fabric 151 is passed through a third roll group 152 which includes dancer rolls and thereby intermittently conveyed and, further, passes through gather rolls 154. The gather rolls 154 have continuous sawtooth shaped blades (not shown) at their surfaces in their peripheral directions. Due to this, the nonwoven fabric 151 which passes the gather rolls 154 is formed with sawtooth shaped slits (not shown). Due to the above, the sheet with slits 7 is formed from the nonwoven fabric 151.

The sheet with slits 7 merges with the multilayer web S3 at the merging part 156 to form the multilayer web S4.

In the present embodiment, the first melt bonded part forming device 158 is used to melt bond the multilayer web S4 as a whole whereby the multilayer web S4 is formed with the first melt bonded part 8 (see FIG. 3 etc.). Due to this, the multilayer web S4 is melt bonded across its thickness direction. The first melt bonded part forming device 154 is, for example, a heat seal device, ultrasonic wave sealing device, etc. In the present embodiment, a heat seal device is used. As another embodiment, an ultrasonic wave sealing device is used.

The multilayer web S4 which passes the first melt bonded part forming device 158 and which forms a continuous web member is cut by a cutting device 160 into a predetermined product length whereby the cleaning-use web member 1 is produced.

The cleaning-use web member 1 in the present embodiment includes a sheet with slits 7, but a cleaning-use web member of another embodiment does not include a sheet with slits.

Further, in the cleaning member 1 of the present embodiment, the receiving parts 14 are positioned at the surface of the cleaning member 1. In another embodiment, by changing the order of overlay of the substrate sheet 12 and the holding sheet 13 and the fibrous members 3 to 6, the receiving parts 14 are arranged between any adjoining fibrous members 3 to 6. Due to this, the two surfaces of the cleaning-use web member 1 can be used for cleaning. At this time, to facilitate insertion of the insert parts 16 into the receiving parts 14, the dimensions of the substrate sheet 12 and the holding sheet 13 in the long direction (up-down direction of FIG. 3) are preferably made longer than the fibrous members 3 to 6. These dimensions are suitably determined in accordance with the design specifications etc. Further, in another embodiment, the sheet with slits need not be included as a component of the cleaning-use web member or may be arranged at the two front and back surfaces of the cleaning-use web member 1.

In this regard, the multilayer web S4 which forms the continuous web member (that is, the cut-free continuous web member) is cut by the cutting device 160 to a predetermined product length, but regarding this cutting device 160, as explained above, to avoid the melt bonding or press bonding which occurs between tows at the time of cutting, a cutting device which conveys the continuous web member intermittently and, while the continuous web member has stopped being conveyed, makes a disk-shaped rotary blade member rotate about a rotation axis along the machine direction while makes it reciprocate in a perpendicularly intersecting direction which perpendicularly intersects the machine direction so as to cut the continuous web member is being developed.

In such a cutting device 160, a drive mechanism becomes necessary for making the disk-shaped rotary blade reciprocate. Such a drive mechanism is configured having a movement mechanism which moves together with the rotary blade member and a guide mechanism such as a rail mechanism which is immovably fastened and which guides reciprocating movement of the movement mechanism. Further, to enable smooth movement of the movement mechanism with respect to the guide mechanism, a ball bearing or other such bearing is provided between the guide mechanism and the movement mechanism. Such a bearing is generally provided with a seal mechanism to avoid refuse etc. which would hinder the function from entering into the bearing etc.

However, when the cutting device 160 cuts the multilayer web S4 which forms the continuous web member into a predetermined product length, since the tow is cut, fiber waste is produced. This fiber waste is fine in size. Further, sometimes the amount is also large. If an unforeseen large amount of fine fiber waste which would exceed the sealing ability of a bearing were to be produced and deposit on the sliding surface of the bearing, the fiber waste would end up entering the inside of the bearing. This would sometimes obstruct the operation of the system.

In view of this problem, the present invention provides a cutting device of a web member including a tow which has means designed to be able to block the entry of fiber waste which is produced when cutting the continuous web member to the inside of a bearing which is provided so as to cause smooth reciprocating movement of a rotary blade member.

FIG. 5 is a view which shows an outline of the layout of a cutting device, while FIG. 6 is a schematic view of a cutting device. Further, FIG. 7 is a view which explains the operation of a cutting device, while FIG. 8 is a view which shows the configuration of a part A in FIG. 6. In FIG. 5 to FIG. 7, 201 indicates a rotary blade member, 202 a first power transmission mechanism, 203 a second power transmission mechanism, 204 an anvil mechanism, 205 a first power generator, and 206 a second power generator. Further, in FIG. 8, 300 indicates a movement mechanism, 301 a holder, 302 a holder-use support member, 303 a bearing, 304 a holder-use fastener, 310 a guide mechanism, 311 a rail member, 312 a rail member-use support member, and 313 a guide surface.

As will be understood from FIG. 5, the cutting device 160 is arranged at a downstream side of the production line from the first melt bonded part forming device 158 and performs the role of cutting the multilayer web S4 which forms the continuous web member so as to form a web member 1 which has a predetermined product length.

The rotary blade member 201 is formed as a disk-shaped member and rotates by itself while the multilayer web S4 which forms the continuous web member has stopped being conveyed and reciprocates in the perpendicularly intersecting direction which perpendicularly interests the machine direction of the multilayer web S4 so as to cut the multilayer web S4 which forms the continuous web member into a predetermined product length. The cutting device 160 of the embodiment which is shown in FIG. 7 is comprised having two rotary blade members 201. In cutting devices according to the present invention in other embodiments, the device is comprised having a single rotary blade member or three or more rotary blade members.

The anvil mechanism 204 is configured having an interface part which is rotably attached to the rotary blade member 201 and provided with a second power generator 206 for driving rotation of the rotary blade member 201.

The first power transmission mechanism 202 and the second power transmission mechanism 203 cooperate to perform the role of causing reciprocating movement of the anvil mechanism 204. The first power transmission mechanism 202 and the second power transmission mechanism 203 in the present embodiment, as will be understood from FIG. 7, are configured to cause reciprocating movement of the anvil mechanism 204 by transmitting rotational torque which has been created by driving a first power generator 205 which is provided at the first power transmission mechanism 202 through a power transmission belt, pulley, or other component from the first power transmission mechanism 202 to the second power transmission mechanism 203.

FIG. 8 shows an embodiment of a movement mechanism 300 which is formed as part of the anvil mechanism 204 and moves together with the rotary blade member 201 and a guide mechanism 310 which is immovably fastened and guides reciprocating movement of the movement mechanism 300. In the present embodiment, the movement mechanism 300 is configured having a holder 301, a holder-use support member 302, a bearing 303 which is formed as a ball bearing, and holder-use fasteners 304. On the other hand, the guide mechanism 310 is configured having a rail member 311 and a rail member-use support 312. Further, in the present embodiment, as the bearing 303, a ball bearing is used, but in another embodiment, another type of bearing which can give smooth movement of the movement mechanism 300 with respect to the guide mechanism 310 may be used.

As will be able to be understood from the configuration which is shown in FIG. 8, the movement mechanism 300 and the guide mechanism 310 are configured so that the sliding parts (ball parts) of the bearing 303 which is provided at the holder 301 of the movement mechanism 300 slide against the AA surface and BB surface forming parts of the guide surfaces 313 which are provided at the rail member 311 of the guide mechanism 310 and which are formed in recessed shapes, whereby reciprocating movement of the movement mechanism 300 with respect to the immovably fastened guide mechanism 310 is caused.

FIG. 9 is a view which shows an embodiment of a waste removing device serving as a means for obstructing entry of fiber waste, which is produced when cutting a multilayer web S4 which forms a continuous web member, to the inside of a bearing 303 which is provided for causing reciprocating movement of the rotary blade member 201 in a cutting device 160 which has such a configuration. Further, FIG. 10 is a perspective view of the configuration of the waste removing device which is shown in FIG. 9. In FIG. 9 and FIG. 10, 400 indicates a waste removing device, 401 a waste removing body, 402 a cover, 403 a fastener for the waste removing body, and 404 a waste removing surface.

As will be understood from FIG. 9, the waste removing device 400 is configured attached to the end of the holder 301 of the movement mechanism 300. More specifically, the waste removing device 400 is configured with a waste removing body 301 attached to an end of the holder 301 of the movement mechanism 300, with a cover 402 attached to an outside surface of the waste removing body 401, and with waste removing body-use fasteners 403 used to fasten the waste removing body 401 and the cover 402 to the holder 301.

The waste removing body 401 is formed having waste removing surfaces 404 which are complementary to the recessed-shape guide surfaces 313 which are formed at the rail member 311 and is configured to be able to remove fiber waste which has deposited on the guide surfaces 313 of the rail member 311 from the guide surfaces. Further, in the present embodiment, the waste removing body 401 is formed by a cloth. Incidentally, as the cloth, a laminate of a woven fabric or a knitted fabric may be used. However, with a woven fabric or a knitted fabric, the ability to remove dirt easily varies depending on the weave or knitted structure, so from the viewpoint of the randomness of fibers, a nonwoven fabric is preferably used as the cloth. Furthermore, among nonwoven fabrics as well, if considering the uniformity of the fibers, needle felt, woven felt, press felt, or other felt is preferable. Further, as the fibers used, one or a mixture of two or more of polyester, nylon, polypropylene, acrylic, rayon, and wool may be used. However, as the fiber which is used at sliding parts, if considering the heat buildup due to friction, rayon or wool is preferably used.

The cover 402 is configured to be placed so that the waste removing body 401 is not damaged when using the waste removing body-use fasteners 403 to fasten the waste removing body 401 to the holder 301.

According to the thus configured waste removing device 400, the waste removing device is attached to an end of the holder 301 of the movement mechanism 300, so when cutting a multilayer web S4 for forming the continuous web member, it is possible to cause reciprocating movement of the waste removing body 401 together with the movement mechanism 300 provided with the rotary blade member 201. Further, the waste removing body 401 is formed having waste removing surfaces 404 which are complementary to the recessed shape guide surfaces 313 which are formed at the rail member 311, so it is made possible to eliminate fiber waste which has deposited at the guide surfaces 313 of the rail member 311 from the guide surfaces. Furthermore, the waste removing body 401 is formed from a cloth which gives a material suited to trapping fiber waste, so it becomes possible to eliminate fiber waste which has deposited at the guide surfaces 313 safely and effectively without damaging the guide surfaces 313 of the rail member 311.

FIG. 11 is a view which shows a waste removing device 500 of another embodiment. More specifically, it is a view which shows a waste removing device 500 which is comprised of the waste removing device in the embodiment which was shown in FIG. 9 to which further a suction device 501 is attached.

That is, in the embodiment which is shown in FIG. 11, the suction device 501 which is attached to the guide mechanism 310 and which is arranged adjoining the rail member 311 so as to be able to suck away fiber waste which has deposited at the guide surfaces 313 of the rail member 311 is provided as a waste removing device, so it becomes possible to more reliably remove fiber waste which has deposited at the guide surfaces 313 of the rail member 311 from the guide surfaces.

The present application claims the benefit of the following patent applications, the entire disclosures of which are incorporated herein by reference:

JP Patent Application No. 2012-289181 filed on Dec. 29, 2012, and US patent application claiming the priority thereof, JP Patent Application No. 2012-289182 filed on Dec. 29, 2012, and US patent application claiming the priority thereof, JP Patent Application No. 2012-289174 filed on Dec. 29, 2012, and US patent application claiming the priority thereof, JP Patent Application No. 2012-289189 filed on Dec. 29, 2012, and US patent application claiming the priority thereof, JP Patent Application No. 2012-289175 filed on Dec. 29, 2012, and US patent application claiming the priority thereof, JP Patent Application No. 2012-289188 filed on Dec. 29, 2012, and US patent application claiming the priority thereof, JP Patent Application No. 2012-289179 filed on Dec. 29, 2012, and US patent application claiming the priority thereof, JP Patent Application No. 2012-289177 filed on Dec. 29, 2012, and US patent application claiming the priority thereof, JP Patent Application No. 2012-289184 filed on Dec. 29, 2012, and US patent application claiming the priority thereof, JP Patent Application No. 2012-289178 filed on Dec. 29, 2012, and US patent application claiming the priority thereof, JP Patent Application No. 2013-002855 filed on Jan. 10, 2013, and US patent application claiming the priority thereof, as well as JP Patent Application No. 2013-002857 filed on Jan. 10, 2013, and US patent application claiming the priority thereof.

### REFERENCE SIGNS LIST

160 cutting device

300 movement mechanism

301 holder

303 bearing

310 guide mechanism

311 rail member

400 waste removing device

401 waste removing body

402 cover

501 suction device

1. A cutting device of a web member including a tow which conveys a continuous web member intermittently and, while the continuous web member has stopped being conveyed, makes a disk-shaped rotary blade member rotate about a rotation axis along the machine direction while makes it reciprocate in a perpendicularly intersecting direction which perpendicularly intersects the machine direction so as to cut the continuous web member into a predetermined product length, which cutting device is provided with
a movement mechanism which moves together with said rotary blade member,
a guide mechanism which is immovably fastened and which guides reciprocating movement of said movement mechanism, and
a bearing which is placed between said guide mechanism and said movement mechanism to enable smooth movement of said movement mechanism with respect to said guide mechanism and, furthermore, is provided with
a waste removing device which is attached to said movement mechanism and which blocks entry of fiber waste which is produced when cutting the continuous web member to the inside of said bearing by removing fiber waste which has deposited on said guide mechanism from said guide mechanism.

2. The cutting device as set forth in claim 1 wherein said guide mechanism has a rail member which has guide surfaces against which said bearing slides and wherein said waste removing device is provided with a waste removing body which is formed having waste removing surfaces which are complementary to said guide surfaces so that fiber waste which has deposited at the guide surfaces of said rail member can be removed.

3. The cutting device as set forth in claim 2 wherein said waste removing body is formed by a cloth.

4. The cutting device as set forth in claim 3 where said waste removing device has a suction device which is attached to said guide mechanism and which is arranged adjoining said rail member so as to be able to suck away fiber waste which has been deposited on the guide surfaces of said rail member.
